(19) United States
(12) Patent Application Publication
(10) Pub. No.: US 2016/0019757 A1
(43) Pub. Date: Jan. 21, 2016

(54) SYSTEMS AND METHODS FOR PROVIDING RACE AND FANTASY SPORTS PARI-MUTUEL WAGERING

(71) Applicants: MICHAEL L. KNAPP, HIDDEN MEADOWS, CA (US); VICTOR SALERNO, HENDERSON, NV (US)

(72) Inventors: MICHAEL L. KNAPP, HIDDEN MEADOWS, CA (US); VICTOR SALERNO, HENDERSON, NV (US)

(21) Appl. No.: 14/331,998

(22) Filed: Jul. 15, 2014

(51) Int. Cl. G07F 17/32

(52) U.S. Cl. CPC G07F 17/3288; G07F 17/3244

(57) ABSTRACT

A method for providing race and sport pari-mutuel wagering by an operator to a player is provided. The method includes providing, by the operator, a first pari-mutuel contest to the player, wherein the first pari-mutuel contest is associated with a race event, providing, by the operator, a second pari-mutuel contest to the player, wherein the second pari-mutuel contest is associated with a sport event, receiving, by the operator, a wager on at least one of the first pari-mutuel contest and the second pari-mutuel contest, and contributing at least a portion of the wager to a pool associated with the at least one of the first pari-mutuel contest and the second pari-mutuel contest, determining a winning outcome associated with the at least one of the first pari-mutuel contest and the second pari-mutuel contest, and paying the player at least a portion of the pool when the wager of the player is associated with the winning outcome.

### BACKGROUND

The field of the disclosure relates generally to offering a contest to a plurality of players, and more specifically to offering a pari-mutuel race contest and a pari-mutuel sport contest to a plurality of players.

Racetracks around the country have been the home of horse and dog racing for more than a century. One of the primary means of funding the operations of the racetrack, including payment of jockey's wages, prize pools, horse-owners fees, track management/maintenance, etc. is revenue from on-track and off-track wagering. On-track wagering is where players place a wager on a racing contest that is being held at the track where the wager is accepted. Alternatively, off-track wagering is where players place wagers on contests that are held at an off-site location away from the live event. Unlike typical wagering on sporting events such as football and basketball, the majority of horse and dog race contests use a “pari-mutuel system” that enables players to play and wager among themselves while an operator of the contest receives a fee based on the total amount wagered.

In known pari-mutuel systems, a contest with a plurality of participants, e.g., horses in a horse race, and a defined winning outcome, e.g., win, place, show, etc., is offered to players. The players place a wager on at least one of the participants to achieve the winning outcome, and place the wager into a prize pool. The prize pool for the contest is the total amount wagered by the players, less a commission by the operator. After the outcome of the race is determined, the players that wagered on participants achieving the winning outcome split the pool in a proportionate ratio to the amount wagered. For example, if $500 dollars of a $1,000 dollar pool was wagered on the winning outcome, the payout would be 2 to 1. However if $50 dollars of a $1,000 dollar pool was wagered on the winning outcome, the payout would be 20 to 1. Accordingly, the odds associated with each participant, and the amount of money won on successful wagers, constantly change to reflect new wagers entered into the pool. The pari-mutuel system offers several advantages over traditional sport wagering. In particular, because the players wager amongst themselves, the operator receives its commission regardless of the outcome of the event. As the operator is not setting odds and participating in the bets, the operator's costs and risks are reduced. Additionally, skilled players can consistently earn more money than they wager by playing directly against less skilled players. Finally, some pari-mutuel contests, e.g., exactas and trifectas, can pay out at very high ratios, e.g., 100 to 1, without risk to the operator.

However, pari-mutuel wagering has not expanded beyond traditional racing events. In particular, the relatively few participants in team-based sporting contests, e.g., team vs. team, negates the advantages of pari-mutuel wagering over standard money-line bets. However, in recent years, fantasy sports contests associated with individual athlete performance have grown in popularity. Specifically, a large number of daily and weekly fantasy sporting contests are held where players select a particular athlete, or team of athletes, competing in one or more sporting events to represent them. After the one or more sporting events are completed, the athletes are each assigned a score based their personal statistical performance. The players that selected the athlete, or team of athletes, with the highest value based on statistical performance are declared the winners. With a large number of potential athletes to select, fantasy sports contests have sufficient participants to advantageously be subjected to pari-mutuel wagering systems.

While some operators have offered fantasy sports contests with a pari-mutuel system, adoption of the system has been slow. In particular, there are costs associated with determining the pool and odds at any given time. In addition, players that typically bet on sporting events are unfamiliar with the pari-mutuel system. Accordingly, it may be advantageous to provide players a pari-mutuel race contest and a pari-mutuel fantasy sport contest.

### BRIEF DESCRIPTION OF THE DRAWINGS

FIGS. 1-5 show example embodiments of the method and system described herein.

FIG. 1 is a schematic diagram illustrating an exemplary pari-mutuel wagering system for enabling players to wager on racing events and fantasy sporting events.

FIG. 2 is a schematic diagram of an example wagering network for use in enabling players to wager on off-track racing events and fantasy sporting events.

FIG. 3 illustrates an example configuration of a player computing device as shown in FIG. 2.

FIG. 4 illustrates an example configuration of a server system as shown in FIG. 2.

FIG. 5 is a simplified flowchart illustrating an example process implemented by the operator to enable pari-mutuel wagering on racing events and fantasy sporting events.

### DETAILED DESCRIPTION OF THE DISCLOSURE

In recent years, fantasy sports has enabled the individual performance of athletes to be measured and compared in a statistical manner. However, despite its popularity, wagering on fantasy sports is currently complicated for both players and operators due to the difficulty of handicapping and setting the relative odds for each game.

In addition, racetracks have been searching for new methods of interesting a younger audience. In particular, racetracks search for additional content for their customer to wager on. However, because the pari-mutuel wagering system is ill-suited to popular team-based games, such as football, the racetracks have been unable to offer games that are easily integrated into their current structure.

In a fantasy sport setting, the statistical performance of each athlete has enabled a substantially objective metric of performance through which the individual athletes may be ranked from first to last on a daily, weekly, or seasonal basis. Accordingly, betting on fantasy sports contests can be easily integrated into the current wagering structure offered by racetracks, and, due to the pari-mutuel system, the operator does not need to accurately determine the odds associated with each athlete as the players ultimately accomplish this function through the pari-mutuel platform.

As used herein, the term “fantasy sport” refers to any suitable sporting event in which human athletes participate such as, football, basketball, hockey, baseball, tennis, golf, soccer, auto racing, cycling, and/or any other similar activity.

As used herein, the term “race event” refers to any suitable event in which a plurality of non-human entities compete in a race. Non limiting examples of race events include dog racing and horse racing.

The detailed description illustrates embodiments of the disclosure by way of example and not by way of limitation. It is contemplated that the disclosure has general application to systems and methods that facilitate pari-mutuel wagering. However, this disclosure is not intended to be limited to the embodiments described herein, but could be used in various other embodiments that are also covered by this disclosure.

The present invention provides a pari-mutuel race and fantasy sport wagering system and method. In the preferred embodiment, the system and method are implemented on one or more computer systems and/or networks. Particularly, the system and method may be implemented using software, hardware, firmware, or any combination thereof, as would be apparent to those of ordinary skill in the art. The figures and examples below are not meant to limit the scope of the present disclosure, and are instead only illustrative examples. Where certain elements of the disclosure can be partially or fully implemented using known components and processes, only those portions of such known components and processes that are necessary for an understanding of the present invention will be described, and detailed descriptions of the known components and processes will be omitted so as not to obscure the invention.

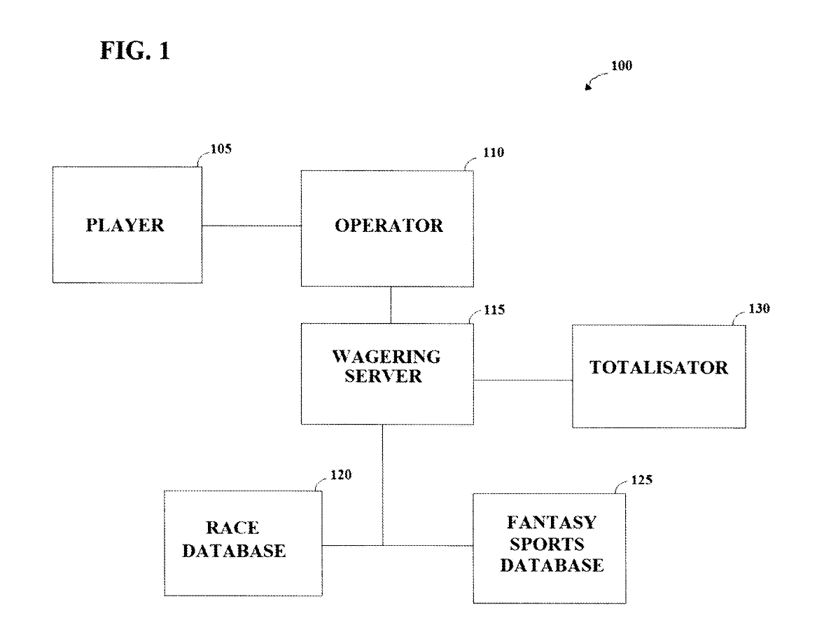

FIG. 1 is a schematic diagram illustrating an exemplary pari-mutuel wagering system 100 for enabling players 105 to wager on racing events and fantasy sporting events. Pari-mutuel wagering system 100 includes an operator 110 that maintains a wagering server 115. Wagering server 115 is communicatively coupled to a race database 120 and a fantasy sports database 125. Race database 120 includes data associated with at least one non-human racing event, such as horse racing and/or dog racing. Fantasy sports database 125 includes data associated with a plurality of sporting events. In particular, fantasy sports database 125 includes data associated with the statistical performance of a plurality of athletes competing in at least one sporting event. Pari-mutuel wagering system 100 also includes at least one totalisator 130 and/or other computing device configured to determine the current odds to win associated with any particular race participant or athlete in a fantasy sports contest.

In operation, player 105 interacts with operator 110 through, for example, a teller. Operator 110 provides player 105 with a first pari-mutuel contest on which player 105 may place a wager. The first pari-mutuel contest may be any type of pari-mutuel contest, including, without limitation, win, place, show, exacta, trifecta, perfecta, pick six, and/or any other pari-mutuel contest. The first contest is associated with a plurality of race participants competing in at least one racing event at a racetrack. The race participants may be associated with the racetrack of the operator in an on-track betting scenario, or may be located at another racetrack in an off-track betting scenario. Data associated with the race event and race participants, such as current odds of each race participant, is stored in race database 120.

Operator 110 also provides player 105 with a second pari-mutuel contest on which player 105 may place a wager. The second pari-mutuel contest may be any type of pari-mutuel contest, including, without limitation, win, place, show, exacta, trifecta, perfecta, pick six, and/or any other pari-mutuel contest. The second pari-mutuel contest is associated with a plurality of athletes competing in a sporting event, or a series of sporting events. Data associated with the sporting events and/or the athletes, such as current odds associated with each athlete, is stored in fantasy sport database 125. Player 105 places a wager on at least one of the first pari-mutel contest and the second pari-mutuel contest, and operator 110 records the wager in wagering server 115. Wagering server 115 transmits the wager to totalisator 130 and receives updated odds information from totalisator 130. Wagering server 115 updates race database 125 and/or fantasy sports database 130 based on the updated odds information. In at least one embodiment, operator 110 receives at least one wager from player 105 during the course of the racing and/or sporting event, typically referred to as in-run betting.

At the conclusion of the race event, race participants are ranked from first to last. The winning outcome of the first pari-mutuel contest is determined based on the ranking of the race participants, and players 105 associated with the winning outcome are paid out.

At the conclusion of the one or more sporting events, athletes are ranked from first to last according to their statistical performances. For example, quarterbacks in a football game may be ranked based on any combination of passing yards, touchdowns, rushing yards, and interceptions. The winning outcome of the second pari-mutuel contest is determined based on the ranking of the athletes, and players 105 associated with the winning outcome are paid out. Although described as a single athlete, some pari-mutuel contests may be based on the statistical performance of a team of athletes, such as a fantasy football team.

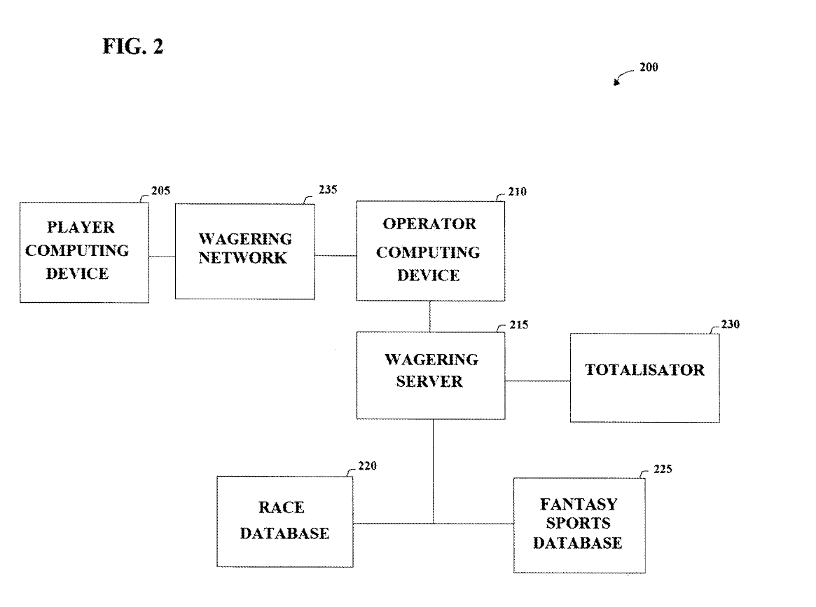

FIG. 2 is a schematic diagram of an example pari-mutuel wagering system 200 for use in enabling players to wager on off-track racing events and fantasy sporting events through player computing device 205. Pari-mutuel wagering system 200 includes an operator computing device 210 that is communicatively coupled to a wagering server 215. Wagering server 215 is communicatively coupled to a race database 220, a fantasy sports database 225. Race database 220 includes data associated with at least one non-human racing event, such as horse racing and/or dog racing. Fantasy sports database 225 includes data associated with a plurality of sporting events. In particular, fantasy sports database 225 includes data associated with the statistical performance of a plurality of athletes competing in at least one sporting event. Pari-mutuel wagering system 200 also includes at least one totalisator 230 and/or other computing device configured to determine the current odds associated with any particular race participant or athlete to achieve a winning outcome.

In operation, player computing device 205 interacts with operator computing device 210 over a wagering network 235. Wagering network 235 may be, for example, the internet. Operator computing device 210 provides player computing device 205 with a first pari-mutuel contest on which the player may place a wager. The first pari-mutuel contest may be any type of pari-mutuel contest, including, without limitation, win, place, show, exacta, trifecta, perfecta, pick six, and/or any other pari-mutuel contest. The first contest is associated with a plurality of race participants competing in at least one racing event at a racetrack. The race participants may be associated with the racetrack of the operator in an on-track betting scenario, or may be located at another racetrack in an off-track betting scenario. Data associated with the race event and race participants, such as current odds of each race participant, is stored in race database 220. Operator computing device 210 also provides player computing device 205 with a second pari-mutuel contest on which player 105 may place a wager. The second pari-mutuel contest may be any type of pari-mutuel contest, including, without limitation, win, place, show, exacta, trifecta, perfecta, pick six, and/or any other pari-mutuel contest. The second pari-mutuel contest is associated with a plurality of athletes competing in a sporting event. Data associated with the sporting event and/or the athletes, such as current odds of each athlete is stored in fantasy sport database 225. The player places a wager through player computing device 205 on at least one of the first pari-mutel contest and the second pari-mutuel contest, and operator computing device 210 records the wager in wagering server 215. Wagering server 215 transmits the wager to totalisator 230 and receives updated odds information 130. Wagering server 215 is configured to update race database 225 and/or fantasy sports database 230 based on the updated odds information.

At the conclusion of the race event, race participants are ranked from first to last. The winning outcome of the first pari-mutuel contest is determined based on the ranking of the race participants, and the players associated with the winning outcome are paid out.

At the conclusion of the sporting event, athletes are ranked from first to last according to their statistical performance. The winning outcome of the second pari-mutuel contest is determined based on the ranking of the athletes, and the players associated with the winning outcome are paid out. Although described as a single athlete, some pari-mutuel contests may be based on the statistical performance of a team of athletes, such as a fantasy football team.

The detailed description illustrates embodiments of the disclosure by way of example and not by way of limitation. It is contemplated that the disclosure has general application to systems and methods that facilitate pari-mutuel wagering. However, this disclosure is not intended to be limited to the embodiments described herein, but could be used in various other embodiments that are also covered by this disclosure.

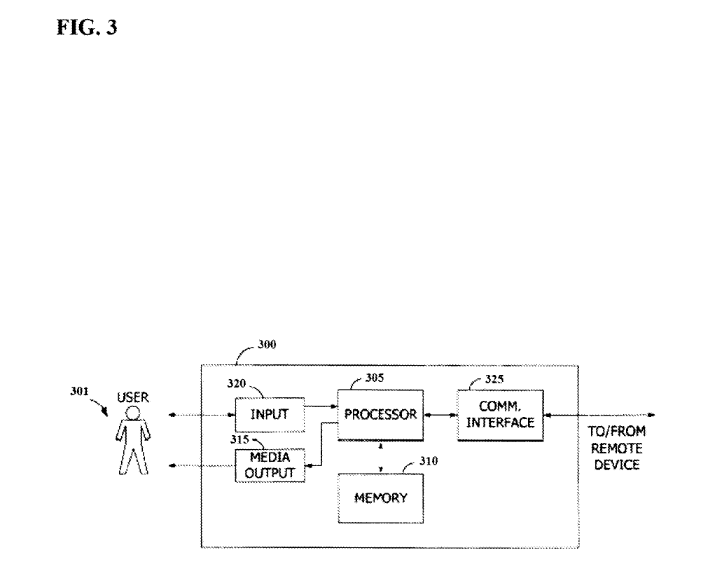

FIG. 3 illustrates an example configuration of a user system 300 operated by a user 301, such as the user of player computing device 205. User system 300 may include, but is not limited to, player computing device 205 and operator computing device 210. In the example embodiment, user system 300 includes a processor 305 for executing instructions. In some embodiments, executable instructions are stored in a memory area 310. Processor 305 may include one or more processing units, for example, a multi-core configuration. Memory area 310 is any device allowing information, such as executable instructions and/or written works, to be stored and retrieved. Memory area 310 may include one or more computer readable media.

User system 300 also includes at least one media output component 315 for presenting information to user 301. Media output component 315 is any component capable of conveying information to user 301. In some embodiments, media output component 315 includes an output adapter such as a video adapter and/or an audio adapter. An output adapter is operatively coupled to processor 305 and operatively couplable to an output device such as a display device, a liquid crystal display (LCD), organic light emitting diode (OLED) display, or “electronic ink” display, or an audio output device, such as a speaker or headphones.

In some embodiments, user system 300 includes an input device 320 for receiving input from user 301. Input device 320 may include, for example, a keyboard, a pointing device, a mouse, a stylus, a touch sensitive panel, a touch pad, a touch screen, a gyroscope, an accelerometer, a position detector, and/or an audio input device. A single component such as a touch screen may function as both an output device of media output component 315 and input device 320. User system 300 may also include a communication interface 325, which is communicatively couplable to a remote device such as wagering server 215. Communication interface 325 may include, for example, a wired or wireless network adapter or a wireless data transceiver for use with a mobile phone network, Global System for Mobile communications (GSM), 3G, or other mobile data network such as WIMAX.

Stored in memory area 310 are, for example, computer readable instructions for providing a user interface to user 301 via media output component 215 and, optionally, receiving and processing input from input device 320. A user interface may include, among other possibilities, a web browser and client application. Web browsers enable users, such as user 301, to display and interact with media and other information typically embedded on a web page or a website from wagering server 215. A client application allows user 301 to interact with a server application from wagering server 215.

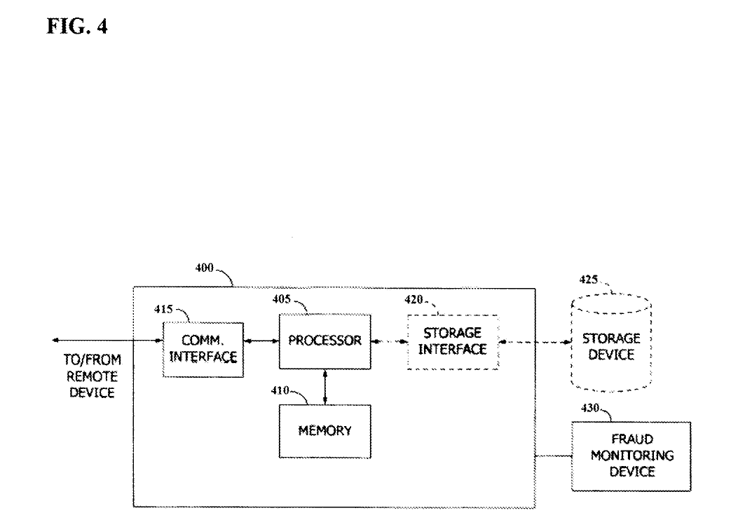

FIG. 4 illustrates an example configuration of a server system 400 such as wagering server system 215 (shown in FIG. 2). Server system 400 includes a processor 405 for executing instructions. Instructions may be stored in a memory area 410, for example. Processor 405 may include one or more processing units (e.g., in a multi-core configuration) for executing instructions. The instructions may be executed within a variety of different operating systems on server system 400. It should also be appreciated that upon initiation of a computer-based method, various instructions may be executed during initialization. Some operations may be required in order to perform one or more processes described herein, while other operations may be more general and/or specific to a particular programming language (e.g., C, C#, C++, Java, or other suitable programming languages, etc.).

Processor 405 is operatively coupled to a communication interface 415 such that server system 400 is capable of communicating with a remote device such as a user system or another server system 400. For example, communication interface 415 may receive requests from player computing device 205 via the Internet, as illustrated in FIG. 2.

Processor 405 may be operatively coupled to a storage device 425. Storage device 425 is any computer-operated hardware suitable for storing and/or retrieving data. In some embodiments, storage device 425 is integrated in server system 400. For example, server system 400 may include one or more hard disk drives as storage device 425. In other embodiments, storage device 425 is external to server system 400 and may be accessed by a plurality of server systems 400. For example, storage device 425 may include multiple storage units such as hard disks or solid state disks in a redundant array of inexpensive disks (RAID) configuration. Storage device 425 may include a storage area network (SAN) and/or a network attached storage (NAS) system.

In some embodiments, processor 405 is operatively coupled to storage device 425 via a storage interface 420. Storage interface 420 is any component capable of providing processor 405 with access to storage device 425. Storage interface 420 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 405 with access to storage device 425.

Memory area 410 may include, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are example only, and are thus not limiting as to the types of memory usable for storage of a computer program.

In at least one embodiment, server system 400 may include a fraud monitoring device 430 configured to compare accounts associated with a user and ensure adequate funds are available for each bet.

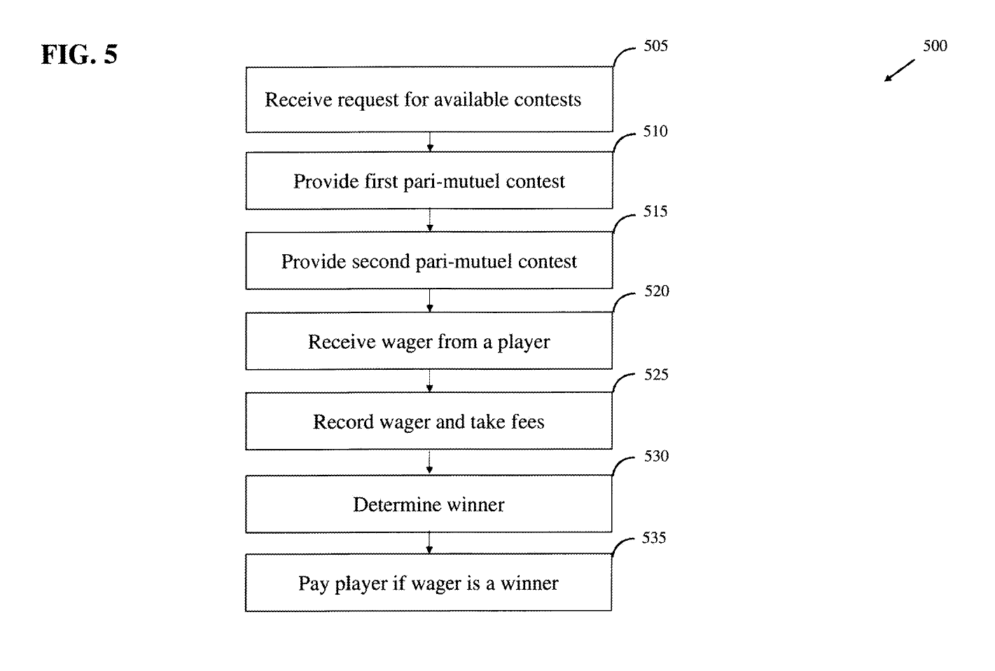

FIG. 5 is a simplified flowchart illustrating an example process 500 implemented by operator 110 (shown in FIG. 1) to enable pari-mutuel wagering on racing events and fantasy sporting events.

In the example embodiment operator 110 receives 505 a request for available contests from player 105. Operator 110 provides 510 player 105 with a first pari-mutuel contest on which player 105 may place a wager. The first pari-mutuel contest is associated with a plurality of race participants competing in at least one racing event at a racetrack. The race participants may be associated with the racetrack of the operator in an on-track betting scenario, or may be located at another racetrack in an off-track betting scenario.

Operator 110 also provides 515 player 105 with a second pari-mutuel contest on which player 105 may place a wager. The second pari-mutuel contest is associated with a plurality of athletes competing in a sporting event.

Operator 110 receives 520 a wager on at least one of the first pari-mutel contest and the second pari-mutuel contest, and records 525 the wager in wagering server 115. In the example embodiment, operator 110 records the wager by taking a portion of the wager as a fee and transmitting the remainder of the wager to the pool for the contest. Also in the example embodiment, operator 110 transmits the wager to totalisator 130 and receives updated odds information.

At the conclusion of the race event and/or the sporting event, operator 110 determines 530 the winning outcomes associated with the first pari-mutuel contest and the second pari-mutuel contest. Operator 110 pays 535 player 105 a portion of the pool when the wager of player 105 is associated with a winning outcome.

The above-described embodiments provide a method and system of enabling pari-mutuel wagering on racing and sporting events. Specifically, operators offer a first pari-mutuel contest associated with a race event and a second pari-mutuel contest associated with a sporting event. The first pari-mutuel sporting event and the second pari-mutuel contest may use the same totalisator, display equipment, and pari-mutuel calculation software, facilitating reducing overhead cost.

The term processor, as used herein, refers to central processing units, microprocessors, microcontrollers, reduced instruction set circuits (RISC), application specific integrated circuits (ASIC), logic circuits, and any other circuit or processor capable of executing the functions described herein.

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are examples only, and are thus not limiting as to the types of memory usable for storage of a computer program.

Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

The operations described herein may be performed by a computer or computing device. A computer or computing device may include one or more processors or processing units, system memory, and some form of computer readable media. Exemplary computer readable media include flash memory drives, digital versatile discs (DVDs), compact discs (CDs), floppy disks, and tape cassettes. By way of example and not limitation, computer readable media comprise computer-readable storage media and communication media. Computer-readable storage media are tangible and non-transitory and store information such as computer readable instructions, data structures, program modules, or other data. Communication media, in contrast, typically embody computer readable instructions, data structures, program modules, or other data in a transitory modulated data signal such as a carrier wave or other transport mechanism and include any information delivery media. Combinations of any of the above are also included within the scope of computer readable media.

This written description uses examples to describe the disclosure, including the best mode, and also to enable any person skilled in the art to practice the disclosure, including making and using any devices or systems and performing any incorporated methods. The patentable scope of the application is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method for providing race and fantasy sport pari-mutuel wagering by an operator to a player, said method comprising:
providing, by the operator, a first pari-mutuel contest to the player, wherein the first pari-mutuel contest is associated with a race event;
providing, by the operator, a second pari-mutuel contest to the player, wherein the second pari-mutuel contest is associated with a sports event;
receiving, by the operator, a wager on at least one of the first pari-mutuel contest and the second pari-mutuel contest, and contributing at least a portion of the wager to a pool associated with the at least one of the first pari-mutuel contest and the second pari-mutuel contest;
determining a winning outcome associated with the at least one of the first pari-mutuel contest and the second pari-mutuel contest; and
paying the player at least a portion of the pool when the wager of the player is associated with the winning outcome.

2. A method in accordance with claim 1, wherein the operator is a racetrack operator, and the race event is held at a racetrack associated with the racetrack operator.

3. A method in accordance with claim 1, wherein the operator is a racetrack operator, and the race event is held at a racetrack not associated with the racetrack operator.

4. A method in accordance with claim 1, wherein the first pari-mutuel contest is associated with at least one of a horse race and a dog race.

5. A method in accordance with claim 1, wherein the second pari-mutuel contest is associated with at least one of a football player, basketball player, hockey player, baseball player, soccer player, tennis player, golfer, cyclist, and racecar driver.

6. A method in accordance with claim 1, wherein the second pari-mutuel contest is associated with a team of football players, basketball players, hockey players, baseball players, soccer players, tennis players, golfers, jai alai players, and racecar drivers.

7. A method in accordance with claim 1, further comprising ranking a plurality of athletes associated with the sports event from first to last based on statistical performance in the sports event

8. A method in accordance with claim 1, further comprising receiving, by the operator, at least one wager associated with the first pari-mutuel contest during the course of the race event.

9. A method in accordance with claim 1, further comprising receiving, by the operator, at least one wager associated with the second pari-mutuel contest during the course of the sports event.

10. A wagering operator configured to provide race and fantasy sport pari-mutuel wagering to a player, said wagering operator comprising:
a player interface, wherein said player interface is configured to:
provide a first pari-mutuel contest to the player, wherein the first pari-mutuel contest is associated with a race event;
provide a second pari-mutuel contest to the player, wherein the second pari-mutuel contest is associated with a sports event; and
receive a wager on at least one of the first pari-mutuel contest and the second pari-mutuel contest, and contributing at least a portion of the wager to a pool associated with the at least one of the first pari-mutuel contest and the second pari-mutuel contest; and
a wagering server, said wagering server configured to:
determine a winning outcome associated with the at least one of the first pari-mutuel contest and the second pari-mutuel contest; and
determine a payout to the player from the pool when the wager of the player is associated with the winning outcome.

11. A wagering operator in accordance with claim 10, wherein the wagering operator further comprises a racetrack.

12. A wagering operator in accordance with claim 11, wherein the race event is held at the racetrack.

13. A wagering operator in accordance with claim 10, wherein the first pari-mutuel contest is associated with at least one of a horse race and a dog race.

14. A wagering operator in accordance with claim 10, wherein the second pari-mutuel contest is associated with at least one of a football player, basketball player, hockey player, baseball player, soccer player, tennis player, golfer, cyclist, and racecar driver.

15. A wagering operator in accordance with claim 10, wherein the second pari-mutuel contest is associated with a player selecting a plurality of athletes.

16. A wagering operator in accordance with claim 10, wherein the wagering server is further configured to rank a plurality of athletes associated with the sports event from first to last based on statistical performances of the plurality of athletes in the sports event

17. A wagering operator in accordance with claim 10, wherein the teller is further configured to receive at least one wager associated with the first pari-mutuel contest during the course of the race event.

18. A wagering operator in accordance with claim 10, wherein the teller is further configured to receive at least one wager associated with the second pari-mutuel contest during the course of the sports event.
